(19) United States
(12) Patent Application Publication
(10) Pub. No.: US 2018/0124381 A1
(43) Pub. Date: May 3, 2018

(54) STRUCTURED-LIGHT-BASED THREE-DIMENSIONAL SCANNING METHOD, APPARATUS AND SYSTEM THEREOF

(71) Applicants: LITE-ON ELECTRONICS (GUANGZHOU) LIMITED, Guangzhou (CN); Lite-On Technology Corporation, Taipei (TW)

(72) Inventors: Hsing-Hung Chen, Taipei (TW); Chan-Min Chou, Taipei (TW)

(73) Assignees: LITE-ON ELECTRONICS (GUANGZHOU) LIMITED, GUANGZHOU (CN); Lite-On Technology Corporation, Taipei (TW)

(21) Appl. No.: 15/439,962

(22) Filed: Feb. 23, 2017

(30) Foreign Application Priority Data
Nov. 2, 2016 (CN) 201610943774.7

(51) Int. Cl. H04N 13/02

(52) U.S. Cl. CPC H04N 13/0253; H04N 13/0207

(57) ABSTRACT

A structured-light-based three-dimensional scanning method, an apparatus and a system thereof are proposed, where the method includes the following steps. Structured light with scanning patterns is subsequently projected onto a subject by a projector. When the structured light with each of the scanning patterns is projected onto the subject, images of the subject are captured by at least one image capturing device to generate an image set including the images, and tilt angles of the three-dimensional scanning system are measured by an angle detector to generate angle measurements respectively corresponding to each of the images. Whether an angle variation of the image set is too large is determined according to the angle measurements of the images therein, and the image set is flagged when the angle variation is too large. Stereo information of the subject is generated according to the image set when the image set is not flagged.

### CROSS-REFERENCE TO RELATED APPLICATION

This application claims the priority benefit of China application no. 201610943774.7, filed on Nov. 2, 2016. The entirety of the above-mentioned patent application is hereby incorporated by reference herein and made a part of this specification.

### TECHNICAL FIELD

The disclosure relates to a three-dimensional (3D) scanning method, an apparatus, and a system thereof, in particular to, a structured-light-based 3D scanning method, an apparatus, and a system thereof.

### BACKGROUND

Applications of surface-geometry measurement in the field of computer graphics, such as industrial design, reverse engineering, manufacturing component inspection, digital documentation of cultural artifacts, and archaeological artifacts, may extensively require 3D imaging and data analysis.

In terms of time-coded structured light, it is able to provide a refined stereo scanning result. Such scanning approach is to project structured light with different phase shifts and spatial frequencies onto an object surface, to capture multiple images of deformed structure light due to the shape of the object surface by an image capturing device, and to obtain complete surface information of the object through image analysis. However, while the user is capturing images by the image capturing device, some degree of camera shake is inevitable and thereby causes error in follow-up image analysis as well as generates fragmented and disconnected stereo information.

### SUMMARY OF THE DISCLOSURE

Accordingly, a structured-light-based 3D scanning method, an apparatus, and a system thereof are provided in the disclosure, where the accuracy of stereo scanning is enhanced in a low-cost and efficient fashion.

According to one of the exemplary embodiments, the structured-light-based 3D scanning method is adapted to a 3D scanning system having a projector, at least one image capturing device, and an angle detector, wherein the projector, the image capturing device, and the angle detector are disposed on a same platform. The method includes the following steps. Structured light with multiple scanning patterns are subsequently projected onto a subject by the projector so as to scan the subject. When the structured light with each of the scanning patterns is projected onto the subject, images of the subject respectively corresponding to each of the scanning patterns are captured by the image capturing device so as to generate an image set including all the images, and tilt angles of the 3D scanning system are measured by the angle detector so as to generate multiple angle measurements respectively corresponding to each of the images. Whether an angle variation of the image set is too large is determined according to the angle measurements of the images in the image set, and if yes, the image set is flagged. When the image set is not flagged, stereo information of the subject is generated according to the image set.

According to one of the exemplary embodiments, the structured-light-based 3D scanning apparatus includes a projector, at least one image capturing device, an angle detector, and a processor. The processor is coupled to the projector, the image capturing device, and the angle detector. The angle detector, the projector, and the image capturing device are disposed on a same platform. The projector is configured to project structured light with multiple scanning patterns subsequently onto a subject so as to scan the subject. When the structured light with each of the scanning patterns is projected onto the subject, the image capturing device is configured to capture images of the subject respectively corresponding to each of the scanning patterns so as to generate an image set including all the images, and the angle detector is configured to measure tilt angles of the 3D scanning apparatus so as to generate multiple angle measurements respectively corresponding to each of the images. The processor is configured to determine whether an angle variation of the image set is too large according to the angle measurements of the images in the image set and to flag the image set if the determination is yes.

According to one of the exemplary embodiments, the structured-light-based 3D scanning system includes a scanning apparatus and a processing apparatus. The scanning apparatus includes a projector, at least one image capturing device and an angle detector disposed on a same platform, and the processing apparatus is connected to the scanning apparatus. The projector is configured to project structured light with multiple scanning patterns subsequently onto a subject so as to scan the subject. When the structured light with each of the scanning patterns is projected onto the subject, the image capturing device is configured to capture images of the subject respectively corresponding to each of the scanning patterns so as to generate an image set including all the images, and the angle detector is configured to measure tilt angles of the scanning device so as to generate multiple angle measurements respectively corresponding to each of the images. The processing device is configured to determine whether an angle variation of the image set is too large according to the angle measurements of the images in the image set and flag the image set if the determination is yes. When the image set is not flagged, the processing device further generates stereo information of the subject according to the image set.

In order to make the aforementioned features and advantages of the present disclosure comprehensible, preferred embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a block diagram of a 3D scanning apparatus in accordance with one of the exemplary embodiments of the disclosure.

FIG. 2 illustrates a flowchart of a 3D scanning method in accordance with one of the exemplary embodiments of the disclosure.

FIG. 3 illustrates scanning patterns and their intensity distribution curves in accordance with one of the exemplary embodiments of the disclosure.

FIG. 4 illustrates a block diagram of a 3D scanning system in accordance with one of the exemplary embodiments of the disclosure.

To make the above features and advantages of the application more comprehensible, several embodiments accompanied with drawings are described in detail as follows.

### DESCRIPTION OF THE EMBODIMENTS

Some embodiments of the disclosure will now be described more fully hereinafter with reference to the accompanying drawings, in which some, but not all embodiments of the application are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

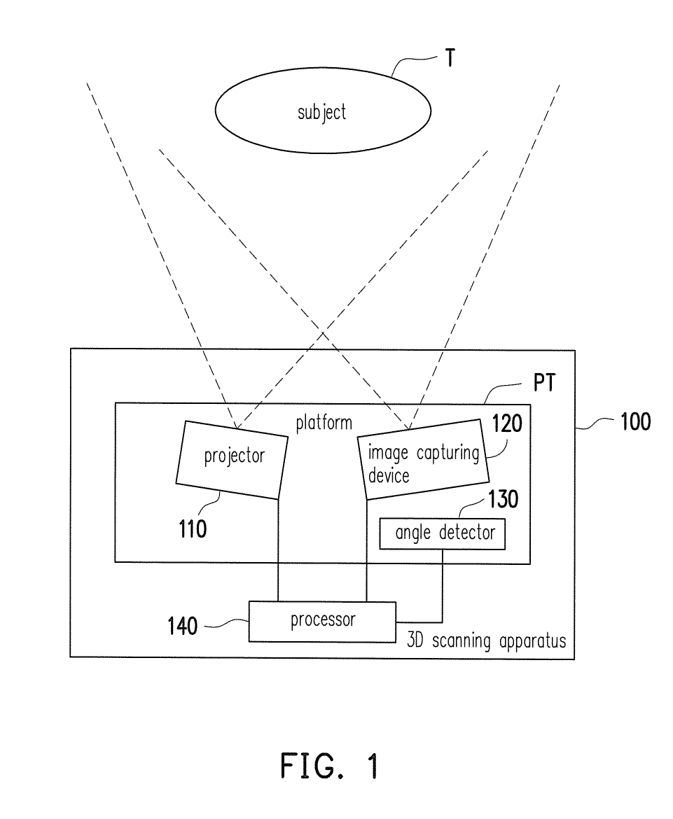

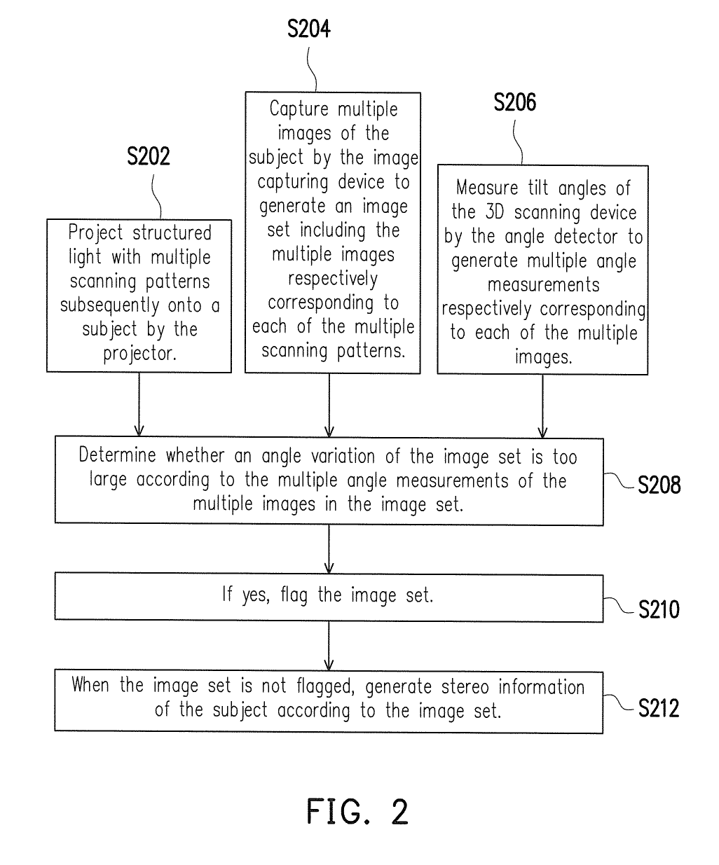

FIG. 1 illustrates a block diagram of a 3D scanning apparatus in accordance with one of the exemplary embodiments of the disclosure. All components of the apparatus and their configurations are first introduced in FIG. 1. The functionalities of the components are disclosed in more detail in conjunction with FIG. 2.

Referring to FIG. 1, a 3D scanning apparatus 100 includes a projector 110, an image capturing device 120, an angle detector 130, and a processor 140. The projector 110, the image capturing device 120, and the angle detector 130 are disposed on a same platform PT, and the processor 140 is coupled to the projector 110, the image capturing device 120, and the angle detector 130. The 3D scanning apparatus 100 may perform scanning on a subject T to obtain its 3D data.

In the present exemplary embodiment, the projector 110 is configured to project structured light onto the subject T for scanning. The projector 110 may be a light-emitting device that projects invisible light such as infrared light. The projector 110 may project structured light with certain scanning patterns (for example, but not limited to, sinusoidal-striped structured light) by settings and adjusting frequencies, phase shifts, region sizes of the projected structured light.

In the present exemplary embodiment, the image capturing device 120 is configured to capture images of the subject T and includes a camera lens and sensing elements. The camera lens includes an optical lens, and the sensing elements are configured to sense light intensity entering the optical lens to thereby generate images. The sensing elements may be, for example, charge-coupled-device (CCD) elements, complementary metal-oxide semiconductor (CMOS) elements. The disclosure is not limited in this regard.

In the present exemplary embodiment, the angle detector 130 is configured to detect a tilt angle of the platform PT and may be, for example, a sensor or integrated circuits for measuring angle such as a gravity sensor, a gyroscope sensor, a tilt sensor.

The disclosure is not limited in this regard. The tilt angle of the platform PT is considered as the tilt angle of the 3D scanning apparatus 100 in the following descriptions.

In the present exemplary embodiment, the processor 140 is coupled to the projector 110, the image capturing device 120, and the angle detector 130, and may be, for example, a central processing unit (CPU) or other programmable devices for general purposes or special purposes such as a microprocessor, a digital signal processor (DSP), a programmable controller, an application specific integrated circuit (ASIC), a programmable logic device (PLD) or other similar devices or a combination of the above-mentioned devices.

One skilled in the art should be appreciated that the 3D scanning apparatus 100 further includes a data memory device (not shown) coupled to the projector 110, the image capturing device 120, the angle detector 130, and the processor 140 and is configured to store images and data. The data storage device may be, for example, one or a combination of a stationary or mobile random access memory (RAM), a read-only memory (ROM), a flash memory, a hard drive or other similar devices.

The detailed steps of the 3D scanning apparatus 100 to perform 3D scanning on the subject T are illustrated in the following embodiments along with each component of the 3D scanning apparatus 100 in FIG. 1.

FIG. 2 illustrates a flowchart of a 3D scanning method in accordance with one of the exemplary embodiments of the disclosure.

Referring to both FIG. 1 and FIG. 2, the projector 110 projects structured light with multiple scanning patterns subsequently onto the subject so as to scan the subject T (Step S202). When the structured light with each of the multiple scanning patterns is projected onto the subject T, the image capturing device 120 captures multiple images of the subject T to generate an image set including the multiple images respectively corresponding to each of the multiple scanning patterns (Step S204), and the angle detector 130 measures tilt angles of the 3D scanning apparatus 100 to generate multiple angle measurements respectively corresponding to each of the multiple images (Step S206). In detail, when the projector 110 projects structured light with each different scanning pattern subsequently onto the subject T, the image capturing device 120 concurrently captures a corresponding image of the subject T, and the angle detector 130 concurrently measures a corresponding tilt angle of the platform PT. In other words, the angle detector 130 measures the tilt angle of the platform PT concurrently when the image capturing device 120 captures each of the images.

In the present exemplary embodiment, each of the scanning patterns has a certain spatial frequency and a certain phase shift. The image capturing device 120 performs image capturing on each of the scanning patterns projected onto the subject T, and all the captured images form an image set.

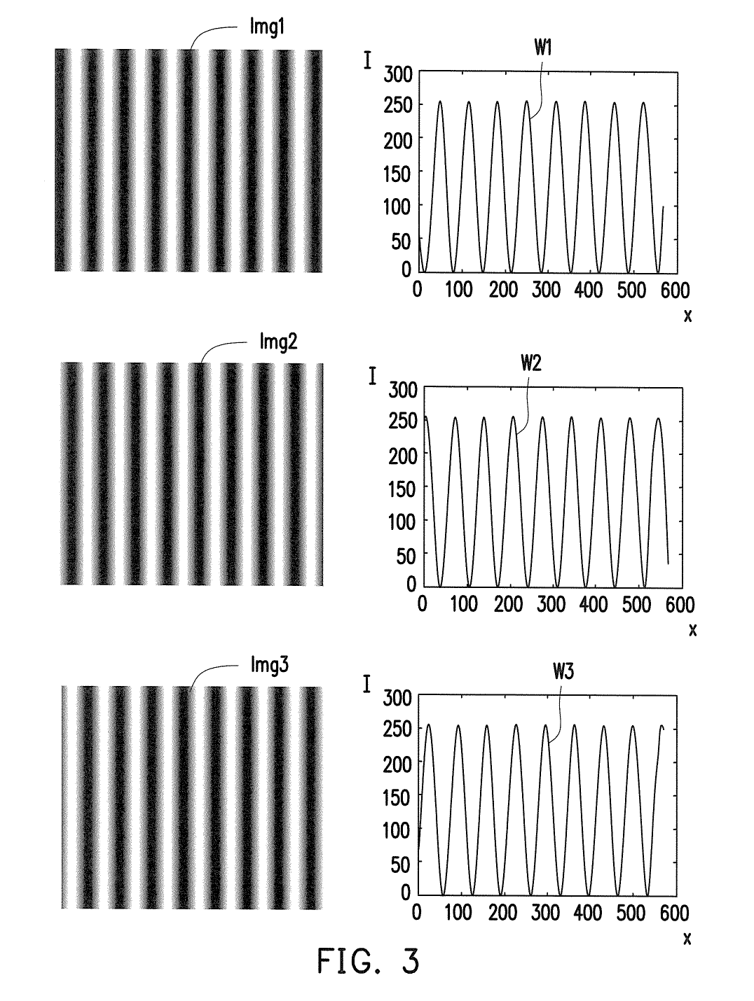

To be specific, the scanning patterns projected by the projector 110 may be three scanning patterns having a first frequency and three phase shifts (e.g. −θ, 0, and θ) respectively, and other three scanning patterns having a second frequency and three phase shifts (e.g. −φ, 0, and φ) respectively. The first frequency and the second frequency are different, and θ and φ may take the same values. For example, FIG. 3 illustrates scanning patterns with their intensity distribution curves in accordance with one of exemplary embodiment of the disclosure. A scanning pattern Img1, a scanning pattern Img2, and a scanning pattern Img3 have the first frequency and the phase shifts −θ, 0, and θ respectively, where θ is 120°. W1, W2, and W3 respectively represent intensity distribution curves of intensity values I of horizontal pixels x in the scanning pattern Img1, the scanning pattern Img2, and the scanning pattern Img3.

When the projector 110 projects the structured light with the first frequency and the phase shift −θ (i.e. the scanning pattern Img1), the image capturing device 120 captures a first image, and a tilt angle measured by the angle detector 130 has a first angle measurement. When the projector 110 projects the structured light with the first frequency and the phase shift 0 (i.e. the scanning pattern Img2), the image capturing device 120 captures a second image, and a tilt angle measured by the angle detector 130 has a second angle measurement. When the projector 110 projects the structured light with the first frequency and the phase shift 0 (i.e. the scanning pattern Img3), the image capturing device 120 captures a third image, and a tilt angle measured by the angle detector 130 has a third angle measurement.

Similarly, when the projector 110 respectively projects the structured light with scanning patterns having the second frequency and the respective phase shifts −φ, 0, and φ, the image capturing device 120 captures a fourth image, a fifth image, and a sixth image, and tilt angles measured by the angle detector 130 have a fourth angle measurement, a fifth angle measurement, and a sixth angle measurement. Herein, the first image, the second image, the third image, the fourth image, the fifth image, and the sixth image form an image set.

In another exemplary embodiment, the 3D scanning apparatus 100 may include two or more image capturing devices 120 to capture images of the subject T.

Referring back to FIG. 2, the processor 140 determines whether an angle variation of the image set is too large according to the multiple angle measurements of the multiple images in the image set (Step S208). If yes, the processor 140 flags the image set (Step S210). In detail, the processor 140 determines whether an angle difference among the angle measurements of all the images in the image set is greater than an angle difference upper limit so as to determine whether the angle variation of the image set is too large. If yes, the processor 140 may flag the image set.

In an exemplary embodiment, the processor 140 may, for example, determine whether an angle difference between every two images in the image set is greater than the angle difference upper limit. If there exist any two images with the angle difference being greater than the angle difference upper limit, the processor 140 may determine that the angle variation of the image set is too large. For example, if an angle difference between the first image and the second image in the aforementioned image set is too large, the processor 140 may flag the image set.

In another exemplary embodiment, the processor 140 may set the angle measurement corresponding to any one image in the image set as an angle reference value and determine whether a difference between the angle measurement of any other images in the image set and the angle reference value is greater than the angle difference upper limit. If there exists any other images with the difference between its angle measurement and the angle reference value being greater than the angle difference upper limit, the processor 140 may determine that the angle variation of the image set is too large. For example, the processor 140 may set the angle reference value of the aforementioned image to the first angle measurement corresponding to the first image and then determine whether a difference between the angle measurement corresponding to each of other images in the image set and the first angle measurement is greater than the angle difference upper limit. If any of the differences is, the processor 140 may flag the image set.

In an exemplary embodiment, since a flagged image set is unreliable, the processor 140 may delete such image set. In another exemplary embodiment, the 3D scanning apparatus 100 may further include an indicating device. When the processor 140 determines that the image set is flagged, it represents that the platform PT is likely to be unstable due to user handshakes. Hence, the processor 140 may emit a warning signal by the indicating device so as to prompt the user to maintain a stability of the platform PT (i.e. the 3D scanning apparatus 100). The user may then start over to perform scanning, image capturing, and angle measurement on the subject T again (i.e. return to Step S202) to re-generate a new image set. Such warning signal may be texts, sounds, light, and so forth. The disclosure is not limited in this regard.

Lastly, when the image set is not flagged, the processor 140 generates stereo information of the subject T according to the image set (Step S212). In detail, after the flagging process is completed, the processor 140 may calculate the depth information of the subject T by using the multiple images in the unflagged image sets. Moreover, the 3D scanning apparatus 100 may perform Steps S202˜S210 on other different regions of the subject T and generate multiple triangular meshes according to depth information of all regions of the subject T so as to construct a complete 3D model of the subject T. Since there already exist many depth information and triangulation algorithms in the field of computer graphics, all of which need not be detailed herein.

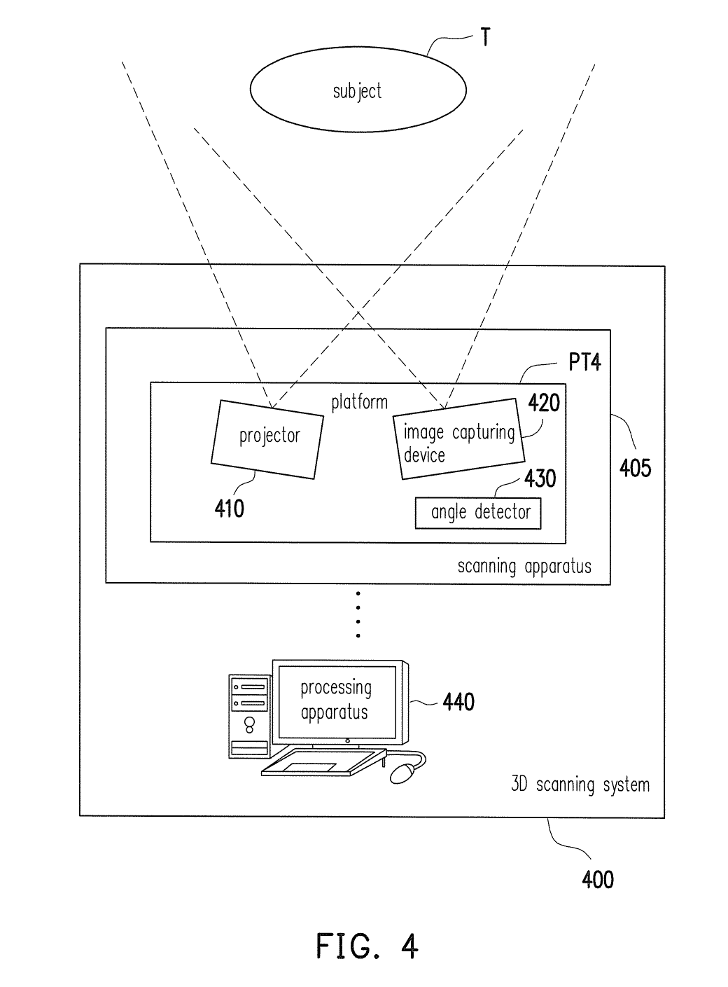

It should be noted that, in an exemplary embodiment, when the processor 140 finishes flagging, it may transmit the image set to an electronic device with a computational feature and a higher efficiency in view of a large amount of computation in Step S212. Moreover, in another exemplary embodiment, a method flow similar to Steps S202-S212 may be accomplished by a 3D scanning system having a scanning apparatus and a processing apparatus as illustrated in FIG. 4 in accordance with one of exemplary embodiments in the disclosure.

Referring to FIG. 4, a 3D scanning system 400 includes a scanning apparatus 405 and a processing apparatus 440, where the scanning apparatus 405 and the processing apparatus 440 may be wiredly or wirelessly connected to each other for data transmission.

The scanning apparatus 405 includes a projector 410, an image capturing device 420, and an angle detector 430 disposed on a same platform PT4, where their functionalities are respectively similar to the projector 110, the image capturing device 120, and the angle detector 130 in FIG. 1. Detailed descriptions may refer to the previous relevant paragraphs and may not be repeated herein. One skilled in the art should be appreciated that the scanning apparatus 405 may include a controller or a control circuit to control the operation of each component as well as a data storage device to store scanning patterns, images captured by the image capturing device 420, and angles measured by the angle detector 430. Moreover, in an exemplary embodiment, the number of the image capturing devices 420 may be two or more.

The processing apparatus 440 may be an electronic device with a computational feature such as a computer, a tabular computer, a smart phone, and so forth and is configured to receive the images captured by the image capturing device 420 and the angles detected by the angle detector 430 to perform the determination and computation of Steps S208-S212 and thereby reduce computation amount and power consumption of the scanning apparatus 405.

In summary, the structured-light-based 3D scanning method, the apparatus and the system thereof use angles measured by an additional angle detector as a basis to construct a 3D model of a subject or to warn the user to maintain his handheld stability and thereby enhance the accuracy of stereo scanning in a low-cost and efficient fashion.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of” multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A structured-light-based three-dimensional scanning method, adapted to a three-dimensional scanning system having a projector, at least one image capturing device, and an angle detector, wherein the projector, the at least one image capturing device, and the angle detector are disposed on a same platform, and wherein the method comprises the following steps:
projecting structured light with a plurality of scanning patterns subsequently onto a subject by a projector so as to scan the subject;
when the structured light with each of the scanning patterns is projected onto the subject, capturing a plurality of images of the subject respectively corresponding to each of the plurality of scanning patterns by the at least one image capturing device so as to generate an image set including the plurality of images and measuring a plurality of tilt angles of the three-dimensional system by using the angle detector so as to generate a plurality of angle measurements respectively corresponding to each of the plurality of images; and
determining whether an angle variation of the image set is too large according to the plurality of angle measurements of the plurality of images in the image set, and if yes, flagging the image set; and
when the image set is not flagged, generating stereo information of the subject according to the image set.

2. The method according to claim 1, wherein the step of determining whether the angle variation of the image set is too large according to the plurality of angle measurements of the plurality of images in the image set comprises:
determining whether a difference among the plurality of angle measurements of the plurality of images in the image set is greater than an angle difference upper limit; and
if yes, determining that the angle variation of the image set is too large.

3. The method according to claim 1, wherein the step of determining whether the angle variation of the image set is too large according to the plurality of angle measurements of the plurality of images in the image set comprises:
setting the angle measurement corresponding to any one image in the image set as an angle reference value;
determining whether a difference between the angle measurement of any of other images in the image set and the angle reference value is greater than an angle difference upper limit; and
if yes, determining that the angle variation of the image set is too large.

4. The method according to claim 1, wherein the three-dimensional scanning system further comprises an indicating device, wherein when the image set is flagged, the method further comprises:
emitting a warning signal by the indicating device so as to prompt to maintain a stability of the platform.

5. The method according to claim 1, wherein when the image set is flagged, the method further comprises:
deleting the image set.

6. The method according to claim 1, wherein when the number of the at least one image capturing device is one, the plurality of scanning patterns at least have a first frequency and a second frequency, and each of the plurality of scanning patterns respectively has one of three different phase shifts.

7. A structured-light-based three-dimensional scanning apparatus, comprising:
a projector, projecting structured light with a plurality of scanning patterns subsequently onto a subject so as to scan the subject;
at least one image capturing device, capturing a plurality of images of the subject respectively corresponding to each of the plurality of scanning patterns so as to generate an image set including the plurality of images when the structured light with each of the plurality of scanning patterns is projected onto the subject;
an angle detector, measuring a plurality of tilt angles of the three-dimensional scanning apparatus so as to generate a plurality of angle measurements respectively corresponding to each of the plurality of images, wherein the angle detector, the projector, and the at least one image capturing device are disposed on a same platform; and
a processor, coupled to the projector, the at least one image capturing device, and the angle detector, determining whether an angle variation of the image set is too large according to the plurality of angle measurements of the plurality of images in the image set, and if yes, flagging the image set.

8. The apparatus according to claim 7, wherein when the image set is not flagged, the processor further generates stereo information of the subject according to the image set.

9. The apparatus according to claim 7 further comprising:
an indicating device, emitting a warning signal to prompt to maintain a stability of the three-dimensional scanning apparatus when the image set is flagged.

10. The apparatus according to claim 8, wherein the processor further deletes the image set when the image set is flagged.

11. A three-dimensional scanning system comprising:
a scanning apparatus, comprising:
a projector, projecting structured light with a plurality of scanning patterns subsequently onto a subject so as to scan the subject;
at least one image capturing device, capturing a plurality of images of the subject respectively corresponding to each of the plurality of scanning patterns so as to generate an image set including the plurality of images when the structured light with each of the plurality of scanning patterns is projected onto the subject; and
an angle detector, measuring a plurality of tilt angles of the scanning apparatus so as to generate a plurality of angle measurements respectively corresponding to each of the plurality of images, wherein the angle detector, the projector, and the at least one image capturing device are disposed on a same platform; and
a processing apparatus, connected to the scanning apparatus, and determining whether an angle variation of the image set is too large according to the plurality of angle measurements of the plurality of images in the image set, flagging the image set if the angle variation is too large, and generating stereo information of the subject according to the image set when the image set is not flagged.

12. The system according to claim 11 further comprising:
an indicating device, connected to the processing apparatus, and emitting a warning signal to prompt to maintain a stability of the scanning apparatus when the image set is flagged.

13. The system according to claim 11, wherein the processing apparatus further deletes the image set when the image set is flagged.
